(19) United States
(12) Patent Application Publication
(10) Pub. No.: US 2023/0024918 A1
(43) Pub. Date: Jan. 26, 2023

(54) Ladder With A Powered Lifting Platform

(71) Applicant: Merna Caraballo, New York, NY (US)

(72) Inventor: Merna Caraballo, New York, NY (US)

(21) Appl. No.: 17/722,478

(22) Filed: Apr. 18, 2022

Related U.S. Application Data
(60) Provisional application No. 63/223,706, filed on Jul. 20, 2021.

(51) Int. Cl. E06C 1/393; E06C 7/16; E06C 7/46; E06C 1/387

(52) U.S. Cl. CPC E06C 1/393; E06C 7/16; E06C 7/46; E06C 1/387

(57) ABSTRACT

A ladder with a powered lifting platform includes a first frame member and a second frame member each having a pair of support legs and an upper crossbar, wherein the first frame member is pivotally connected to the second frame member. Multiple steps are affixed between the pair of support legs of the first frame member. A lifting platform is slidably mounted between the pair of support legs of the second frame member. A powered lift mechanism has a control unit which includes a first control button configured to activate the powered lift mechanism and raise the lifting platform toward the upper crossbars and a second control button configured to activate the powered lift mechanism and lower the lifting platform away from the upper crossbars. The device allows users to safely transport heavier items to the top of the ladder without requiring the user to carry the item.

### CROSS-REFERENCE TO RELATED APPLICATIONS

This application claims the benefit of U.S. Provisional Application No. 63/223,706 filed on Jul. 20, 2021. The above identified patent application is herein incorporated by reference in its entirety to provide continuity of disclosure.

### BACKGROUND OF THE INVENTION

The present invention relates to a ladder with a powered lifting platform. More specifically, the present invention provides a ladder with a powered lifting platform that has controls for automatically locking, raising, or lowering the lifting platform to transport heavier options from the ground to the top of the ladder, or from the top of the ladder back to the ground.

Ladders are utilized to reach raised areas that are normally inaccessible. For individuals working on home construction, repairs, or the like, it is often necessary to transport items to the top of the ladder. For example, individuals may need to transport multiple types of tools and other equipment for performing repairs or other work in an elevated position that cannot normally be reached while standing on the ground. These items are often very heavy and difficult to carry as the individual ascends the ladder. It is possible for an individual to slip and fall due to the additional weight, which can lead to serious injury, regardless of the physical fitness of the individual. Over time, fatigue and other injuries can occur if individuals have to continuously move up and down the ladder while carrying tools or other items. In order to address these concerns, the present invention provides a ladder with a powered lifting platform that can be utilized to automatically transport items to the top of the ladder from the ground, or from the top of the ladder back down to the ground, without requiring items being carried or other manual input from the individual climbing the ladder.

In light of the ladders disclosed in the known art, it is submitted that the present invention substantially diverges in structural and functional elements from the known art. It is clear that there is a need in the art for an improvement to traditional ladders, particularly with regard to the above-described need for a ladder that includes a powered lifting platform for automatically transport items to and from the top of the ladder. In this regard the present invention substantially fulfills these needs.

### SUMMARY OF THE INVENTION

The present invention provides a ladder with a powered lifting platform wherein the same can be utilized for automatically lifting and lowering items to and from the top of the ladder. In general, the ladder with a powered lifting platform includes a first frame member and a second frame member. Each frame member includes a pair of support legs and an upper crossbar. The first frame member is pivotally connected to the second frame member, allowing the ladder to fold from the deployed configuration to a retracted position for compact storage and transportation when not in use. Multiple steps are affixed between the pair of support legs of the first frame member. A lifting platform is slidably mounted between the pair of support legs of the second frame member. A powered lift mechanism, which may include a hydraulic motor, is operably connected to the lifting platform. A control unit is operably connected to the powered lift mechanism. The control unit includes a first control button configured to activate the powered lift mechanism and raise the lifting platform toward the upper crossbars and a second control button configured to activate the powered lift mechanism and lower the lifting platform away from the upper crossbars. The control unit can also include a third control button that provides an interlock control, wherein the third control button is configured to prevent activation of the powered lift mechanism when the third control button is in an engaged position, and wherein the third control button is configured to permit activation of the powered lift mechanism when the third control button is in a disengaged position. This increases the overall safety of the present invention by allowing the user to lock the position of the platform, preventing the user from accidentally raising or lowering the platform unintentionally.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the ladder with a powered lifting platform in a deployed position.

FIG. 2 shows a perspective view of an embodiment of the ladder with a powered lifting platform in a retracted position.

FIG. 3 shows a perspective view of an embodiment of the ladder with a powered lifting platform showing the lifting platform in a lowered position.

FIG. 4 shows a perspective view of an embodiment of the ladder with a powered lifting platform showing the lifting platform in a raised position.

FIG. 5 shows a diagram of the electronic components of an embodiment of the ladder with a powered lifting platform.

### DETAILED DESCRIPTION OF THE INVENTION

Reference is made herein to the attached drawings. Like reference numerals are used throughout the drawings to depict like or similar elements of ladder with a powered lifting platform. For the purposes of presenting a brief and clear description of the present invention, a preferred embodiment will be discussed as used for providing a ladder with a platform that can automatically raise and lower items to and from the top of the ladder.

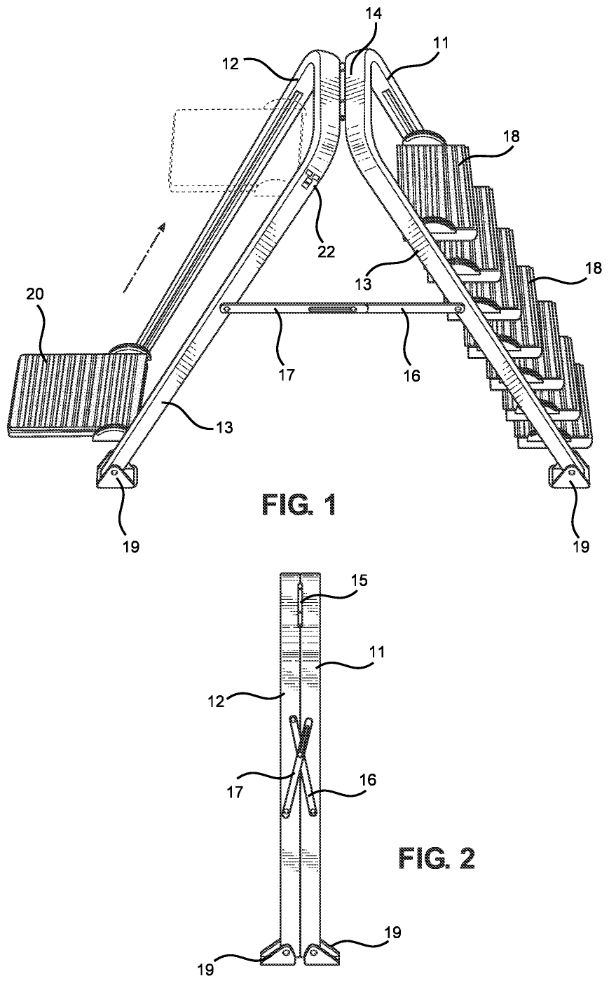

Referring now to FIG. 1, there is shown a perspective view of an embodiment of the ladder with a powered lifting platform in a deployed position. The ladder with a powered lifting platform generally includes a first frame member 11 and a second frame member 12 pivotally attached to form the basic structure of the ladder. Each frame member 11, 12 includes a pair of support legs 13 and an upper crossbar 14. In the shown embodiment, the support legs 13 also include lower supporting feet 19, which may include non-slip materials such as rubber or the like for safety. In the shown embodiment, each non-slip foot 19 is pivotally connected to the lower end of each support leg 13 of the first frame member 11 and the second frame member 12, such that each non-slip foot 19 is automatically adjustable in position to provide a stable support for the ladder regardless of the angle between the first and second frame members 11, 12 when the ladder is moved to the deployed position or retracted position.

In the shown embodiment, the first frame member 11 is pivotally connected to the second frame member 12 via a pivoting brace, which includes a first portion 16 pivotally slidably and pivotally connected to a second portion 17, wherein the first portion 16 is pivotally connected to one of the support legs 13 of the first frame member 11 and the second portion 17 is pivotally connected to one of the support legs 13 of the second frame member 12. The figures show one pivoting brace, but the ladder can include a pair of pivoting braces for additional stability.

A plurality of steps 18 are affixed between the pair of support legs 13 of the first frame member 11. There can be any number of steps 18 depending on the height of the ladder and the desired spacing between individual steps 18. In the shown embodiment, the steps 18 are wide for safety and improved ease of use, and further include a non-slip surface for additional safety. A lifting platform 20 slidably mounted between the pair of support legs 13 of the second frame member 12. A powered lift mechanism is operably connected to the lifting platform 20, which may include a hydraulic motor or a similar motor, including but not limited to an electrically powered linear actuator, as one other example.

A control unit 22 is operably connected to the powered lift mechanism and disposed on the ladder in the shown embodiment. In the shown embodiment, the control unit 22 is positioned on the exterior side of one of the support legs 13 of the second frame member 12. This positioning is ideal for accessing the control unit 22 from different positions, for example if the user is standing on the steps 18, or if the user is standing on the ground adjacent the second frame member 12. The control unit 22 includes at least a first control button configured to activate the powered lift mechanism and raise the lifting platform toward the upper crossbars 14, and a second control button configured to activate the powered lift mechanism and lower the lifting platform away from the upper crossbars 14. In other embodiments, the control unit 22 may be a wireless remote-control unit in a separate housing, which would allow the user to wirelessly control the lifting platform's position from a distance. In such embodiments, the ladder would include a receiver unit operably connected to the lifting mechanism in order to receive control signals from the remote-control device.

Referring now to FIG. 2, there is shown a perspective view of an embodiment of the ladder with a powered lifting platform in a retracted position. In the shown embodiment, the first frame member 11 is pivotally connected to the second frame member 12 via a pair of hinge members 15 affixed to the upper crossbar 14 of the first frame member 11 and a second hinge member 15 affixed to the upper crossbar 14 of the second frame member 12, respectively. The additional upper hinge provides an improved stable connection between the two frame members 11, 12 of the ladder. As shown, the first and second portions 16, 17 of the brace are pivotally and slidably engaged such that the first and second frame members 11, 12 can be folded to be parallel to one another for compact storage and transportation of the ladder when not in use.

In the shown embodiment, each step of the plurality of steps automatically pivots to a retracted position when the first frame member 11 and second frame member 12 are moved to a closed configuration, and automatically pivots to a deployed position when the first frame member 11 and second frame member 12 are moved to an open configuration. This allows the steps 18 to be retracted and out of the way when the ladder is folded to the non-use position. Further, in the shown embodiment, the lifting platform 20 pivots to a retracted position when the first frame member 11 and second frame member 12 are moved to a closed configuration, and pivots to a deployed position when the first frame 11 member and second frame member 12 are moved to an open configuration. The ability of the lifting platform 20 and steps 18 to pivot to be parallel to the frame members 11, 12 when closed, and to pivot to a horizontal position when open, further improves upon the overall usability of the ladder.

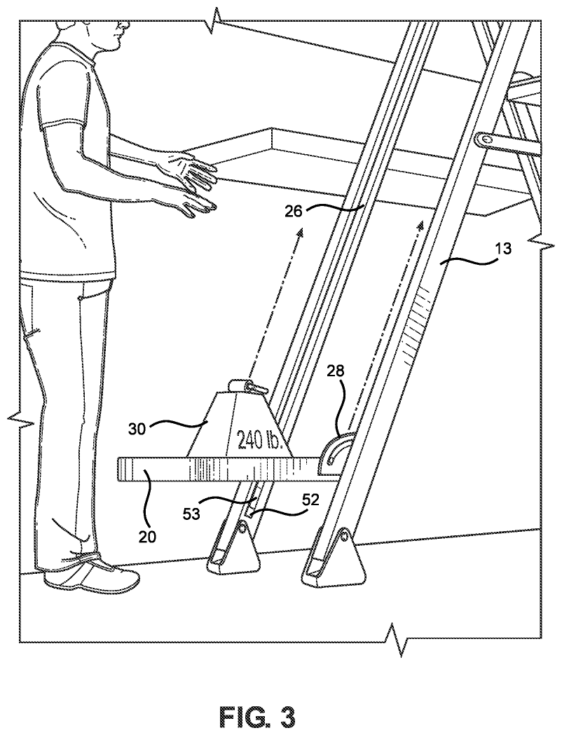

Referring now to FIG. 3, there is shown a perspective view of an embodiment of the ladder with a powered lifting platform showing the lifting platform in a lowered position. As shown, the lifting platform 20 is also pivotally mounted between the pair of support legs 13 via a pair of pivoting brackets 28. The powered lift mechanism 52 is shown positioned at the bottom of the one support leg 13. The powered lift mechanism 52 shown represents a typical hydraulic motor 52 available in the known art. In other embodiments, the powered lift mechanism can be other types of motorized linear actuators.

In the shown embodiment, the powered lift mechanism comprises a pair of hydraulic actuators, each hydraulic actuator comprising a motor 52 disposed within an interior channel 26 of one of the support legs 13 of the second frame member 12 and an actuator rod 53 connected at one end to the motor 52, wherein the lifting platform 20 is connected to an opposing second end of each actuator rod 53. In the shown embodiment, the lifting platform 20 is connected via the bracket 28. When the hydraulic actuator is activated, the motor 52 applies hydraulic pressure to the rod 53, which then forces the platform 20 and any supported items 30 upward along the interior channel 26 of the support legs 13. When the user lowers the lifting platform 20, the hydraulic pressure lessens as the motor 52 retracts the actuator rod 53, allowing the lifting platform 20 to move back toward the ground.

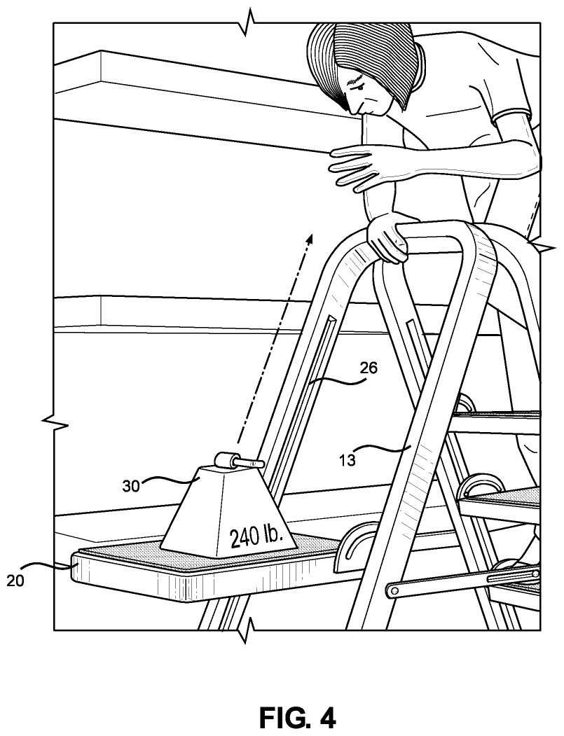

Referring now to FIG. 4, there is shown a perspective view of an embodiment of the ladder with a powered lifting platform showing the lifting platform in a raised position. When the hydraulic motor is activated, the lifting platform 20 and supported item 30 is transported along the interior channel 26 of the support leg 13 toward the user at the top of the ladder. This allows the user to access the item while they are still on the ladder, and the user does not have to carry the item up the ladder as they ascend toward the top. The brace and pivoting connection between the two ladder frame members allows heavier items to be transported without compromising the structural integrity of the ladder.

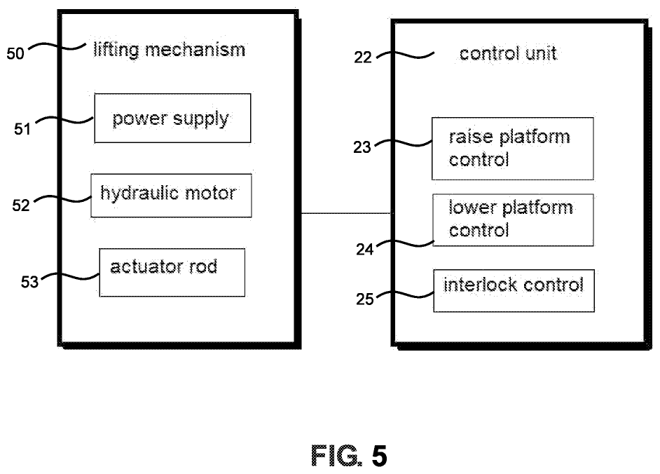

Referring now to FIG. 5, there is shown a diagram of the electronic components of an embodiment of the ladder with a powered lifting platform. The ladder includes a power supply 51 operably connected to the lifting mechanism 50. The power supply 51 can be an onboard battery or a wired connection to an external power source, such as a wall outlet within a building, for example. The power supply 51 powers the hydraulic motor 52, which in turn extends and retracts the actuator rod 53, depending on which direction the user wishes to move the platform attached to the actuator rod 53. The control unit 22 includes controls for raising 23 and lowering 24 the platform, by either extending or retracting the actuator rod 53.

In the shown embodiment, the control unit 22 further comprises a third control button that provides an interlock control 25. The interlock control 25 is configured to prevent activation of the powered lift mechanism 50 and hydraulic motor 52 when the third control button is in an engaged position. This can be accomplished between a typical circuit interrupt that is engaged when the button is moved to a first, depressed position. This allows the user to lock the current position of the lifting platform, so that the user does not accidentally move the lifting platform without meaning to. The third control button is then configured to permit activation of the powered lift mechanism when the third control button is in a disengaged, raised position, which disengages the interlock function. In this way, additional safety is provided, because the user must utilize the third control button to lock or unlock the positioning of the platform.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention.

The foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1. A ladder with a powered lifting platform, comprising:
a first frame member and a second frame member, each frame member having a pair of support legs and an upper crossbar, wherein the first frame member is pivotally connected to the second frame member;
a plurality of steps affixed between the pair of support legs of the first frame member;
a lifting platform slidably mounted between the pair of support legs of the second frame member;
a powered lift mechanism operably connected to the lifting platform;
a control unit operably connected to the powered lift mechanism, the control unit comprising a first control button configured to activate the powered lift mechanism and raise the lifting platform toward the upper crossbars and a second control button configured to activate the powered lift mechanism and lower the lifting platform away from the upper crossbars.

2. The ladder with a powered lifting platform of claim 1, wherein the powered lift mechanism comprises a pair of hydraulic actuators, each hydraulic actuator comprising a motor disposed within an interior channel one of the support legs of the second frame member and an actuator rod connected at one end to the motor, wherein the lifting platform is connected to an opposing second end of each actuator rod.

3. The ladder with a powered lifting platform of claim 1, wherein the first frame member is pivotally connected to the second frame member via a first hinge member affixed to the upper crossbar of the first frame member and a second hinge member affixed to the upper crossbar of the second frame member.

4. The ladder with a powered lifting platform of claim 3, further comprising at least one pivoting brace having a first portion pivotally slidably and pivotally connected to a second portion, wherein the first portion is pivotally connected to one of the support legs of the first frame member and the second portion is pivotally connected to one of the support legs of the second frame member.

5. The ladder with a powered lifting platform of claim 1, further comprising a power supply operably connected to the lifting mechanism.

6. The ladder with a powered lifting platform of claim 1, wherein each step of the plurality of steps is pivotally affixed between the pair of support legs of the first frame member.

7. The ladder with a powered lifting platform of claim 1, wherein the lifting platform is also pivotally mounted between the pair of support legs.

8. The ladder with a powered lifting platform of claim 1, wherein the control unit further comprises a third control button that provides an interlock control, wherein the third control button is configured to prevent activation of the powered lift mechanism when the third control button is in an engaged position, and wherein the third control button is configured to permit activation of the powered lift mechanism when the third control button is in a disengaged position.

9. The ladder with a powered lifting platform of claim 1, wherein each step of the plurality of steps automatically pivots to a retracted position when the first frame member and second frame member are moved to a closed configuration, and automatically pivots to a deployed position when the first frame member and second frame member are moved to an open configuration.

10. The ladder with a powered lifting platform of claim 1, wherein the lifting platform automatically pivots to a retracted position when the first frame member and second frame member are moved to a closed configuration, and automatically pivots to a deployed position when the first frame member and second frame member are moved to an open configuration.

11. The ladder with a powered lifting platform of claim 1, further comprising a non-slip foot affixed to a lower end of each support leg of the first frame member and the second frame member.

12. The ladder with a powered lifting platform of claim 11, wherein each non-slip foot is pivotally connected to the lower end of each support leg of the first frame member and the second frame member, such that each non-slip foot is automatically adjustable in position.
